(19) United States
(12) Patent Application Publication
(10) Pub. No.: US 2026/0361214 A1
(43) Pub. Date: Nov. 12, 2026

(54) LLC CONVERTER CONTROL CIRCUIT AND LLC CONVERTER

(71) Applicant: SANKEN ELECTRIC CO., LTD., Niiza-Shi (JP)

(72) Inventor: Shinji ASO, Niiza-Shi (JP)

(73) Assignee: SANKEN ELECTRIC CO., LTD., Niiza-Shi (JP)

(21) Appl. No.: 19/668,925

(22) Filed: May 6, 2026

(30) Foreign Application Priority Data
May 9, 2025 (JP) 2025-078724

(51) Int. Cl. H02M 3/00; H02M 1/00; H02M 1/088; H02M 3/335

(52) U.S. Cl. CPC H02M 3/01; H02M 1/088; H02M 3/33571; H02M 1/0058

(57) ABSTRACT

An LLC converter control circuit includes a threshold generator, a comparison unit, a frequency upper limit processor, and a control signal generator. The threshold generator generates a first threshold voltage and a second threshold voltage, based on a feedback voltage and an input voltage of an LLC converter. The second threshold voltage is greater in voltage value than the first threshold voltage at no load. The comparison unit performs comparisons between a signal as a resultant of amplification of a resonant voltage and the first and second threshold voltages. The frequency upper limit processor generates first and second inverted signals by processing respective results of the comparisons performed by the comparison unit, in accordance with a resonant current. The control signal generator generates a high side driving signal, based on the first inverted signal, and generates a low side driving signal, based on the second inverted signal.

### CROSS-REFERENCE TO RELATED APPLICATIONS

The application claims priority from Japanese Patent Application No. 2025-078724 filed on May 9, 2025, the entire contents of which are hereby incorporated by reference.

### BACKGROUND

The disclosure related to an LLC converter control circuit and an LLC converter.

Techniques have been proposed with regard to a control device to control a switching circuit for an LLC converter. For example, U.S. Pat. No. 9,019,725 discloses a control device for a resonant converter. The control device for the resonant converter disclosed in this U.S. Patent generates a driving signal, based on a signal from an output voltage detector, a resonant voltage, and an input voltage, and controls an output voltage.

### SUMMARY

An LLC converter control circuit according to one or more embodiments is a control circuit for an LLC converter and is configured to control a high side driving signal and a low side driving signal, based on a resonant voltage. The resonant voltage is a voltage as a resultant of conversion from a resonant current flowing through a resonant circuit configured to resonate through alternate turning-on and turning-off of a high side switch and a low side switch. The high side driving signal is adapted to drive the high side switch. The low side driving signal is adapted to drive the low side switch. The LLC converter control circuit includes a threshold generator, a comparison unit, a frequency upper limit processor, and a control signal generator. The threshold generator is configured to generate a first threshold voltage and a second threshold voltage, based on a feedback voltage and an input voltage of an LLC converter. The first threshold voltage is a threshold voltage for generating the high side driving signal. The second threshold voltage is a threshold voltage for generating the low side driving signal and is greater in voltage value than the first threshold voltage in a case where no load is coupled to the LLC converter. The comparison unit is configured to perform a comparison between a signal as a resultant of amplification of the resonant voltage and each of the first threshold voltage and the second threshold voltage, and is configured to output a result of the comparison between the signal and the first threshold voltage as a first comparison result signal and output a result of the comparison between the signal and the second threshold voltage as a second comparison result signal. The frequency upper limit processor is configured to generate a first inverted signal and a second inverted signal by processing the first comparison result signal and the second comparison result signal, respectively, in accordance with the resonant current of the LLC converter. The control signal generator is configured to generate the high side driving signal, based on the first inverted signal, and generate the low side driving signal, based on the second inverted signal.

An LLC converter according to one or more embodiments includes an LLC converter control circuit, an input power supply, a half bridge circuit, a resonant circuit, a rectifying and smoothing circuit, an output voltage detection circuit, and a resonant current detection circuit. The half bridge circuit includes a high side switch and a low side switch. The resonant circuit is coupled between an output of the half bridge circuit and a ground, and includes a primary winding of a transformer and a resonant capacitor that are coupled in series to each other. The rectifying and smoothing circuit includes a first diode, a second diode, and an output capacitor, and is configured to rectify and smooth a current flowing through a secondary winding of the transformer. The output voltage detection circuit is configured to detect an output voltage. The resonant current detection circuit is configured to detect a resonant current flowing through the resonant circuit. The LLC converter control circuit is configured to control a high side driving signal and a low side driving signal, based on a resonant voltage. The resonant voltage is a voltage as a resultant of conversion from the resonant current flowing through the resonant circuit configured to resonate through alternate turning-on and turning-off of the high side switch and the low side switch. The high side driving signal is adapted to drive the high side switch. The low side driving signal is adapted to drive the low side switch. The LLC converter control circuit includes a threshold generator, a comparison unit, a frequency upper limit processor, and a control signal generator. The threshold generator is configured to generate a first threshold voltage and a second threshold voltage, based on a feedback voltage and an input voltage of the LLC converter. The first threshold voltage is a threshold voltage for generating the high side driving signal. The second threshold voltage is a threshold voltage for generating the low side driving signal and is greater in voltage value than the first threshold voltage in a case where no load is coupled to the LLC converter. The comparison unit is configured to perform a comparison between a signal as a resultant of amplification of the resonant voltage and each of the first threshold voltage and the second threshold voltage, and is configured to output a result of the comparison between the signal and the first threshold voltage as a first comparison result signal and output a result of the comparison between the signal and the second threshold voltage as a second comparison result signal. The frequency upper limit processor is configured to generate a first inverted signal and a second inverted signal by processing the first comparison result signal and the second comparison result signal, respectively, in accordance with the resonant current of the LLC converter. The control signal generator is configured to generate the high side driving signal, based on the first inverted signal, and generate the low side driving signal, based on the second inverted signal.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of an LLC converter according to one or more embodiments.

FIG. 2 is a block diagram illustrating an LLC converter control circuit according to a comparative example.

FIG. 3A is a diagram illustrating operating waveforms according to the comparative example in a case where a voltage resonant capacitor is 0 F.

FIG. 3B is a diagram illustrating operating waveforms according to the comparative example in a case where protection control by a frequency lower limit processor is in operation.

FIG. 3C is a diagram illustrating operating waveforms according to the comparative example in a case with an output current at no load.

FIG. 4A is a diagram illustrating operating waveforms according to the comparative example in a case where the voltage resonant capacitor is 300 pF.

FIG. 4B is a diagram illustrating operating waveforms in the case where the protection control by the frequency lower limit processor is in operation.

FIG. 4C is a diagram illustrating operating waveforms according to the comparative example in a case with an output current at light load.

FIG. 4D is a diagram illustrating operating waveforms according to the comparative example in the case with the output current at no load.

FIG. 5A is a diagram illustrating operating waveforms according to the comparative example in a case where a load is changed from one that causes the output current to be 1 A to no load.

FIG. 5B is a diagram illustrating waveforms according to the comparative example in a case where a first reference voltage and a second reference voltage are set to be lower.

FIG. 6 is a block diagram illustrating a configuration of an LLC converter control circuit according to one example embodiment of the disclosure.

FIG. 7A is a diagram illustrating operating waveforms according to the example embodiment in the case where the voltage resonant capacitor is 300 pF.

FIG. 7B is a diagram illustrating operating waveforms according to the example embodiment in a case where the voltage resonant capacitor is 300 pF and where the protection control by the frequency lower limit processor is in operation.

FIG. 7C is a diagram illustrating operating waveforms according to the example embodiment in a case where the voltage resonant capacitor is 300 pF and where the output current is at no load.

FIG. 8A is a diagram illustrating operating waveforms under a control scheme for the LLC converter according to the example embodiment in the case where the load is changed from the one that causes the output current to be 1 A to no load.

FIG. 8B is a diagram illustrating enlarged operating waveforms during a time period Ta of FIG. 8A.

FIG. 8C is a diagram illustrating enlarged operating waveforms during a time period Tb of FIG. 8A.

FIG. 9 is a graph illustrating output voltage characteristics obtained with the LLC converter control circuit according to the example embodiment and the LLC converter control circuit according to the comparative example in a case where the output current is varied.

### DETAILED DESCRIPTION

Regarding a control device disclosed in U.S. Pat. No. 9,019,725, there is a concern about an occurrence of a malfunction that a frequency of a resonant voltage can excessively rise at no load to cause stoppage of oscillation. Further, the control device disclosed in U.S. Pat. No. 9,019,725 has room for improvement with regard to a rise in output voltage at no load.

It is desirable to provide an LLC converter control circuit that makes it possible to suppress an excessive rise in frequency of a resonant voltage occurring at no load in an LLC converter and thereby achieve stable operation of the LLC converter, and to provide an LLC converter including such an LLC converter control circuit.

An LLC converter 10 and an LLC converter control circuit 100a according to some example embodiments of the disclosure will be described in detail below, together with an LLC converter control circuit 100 according to a comparative example, with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Configuration of LLC Converter 10

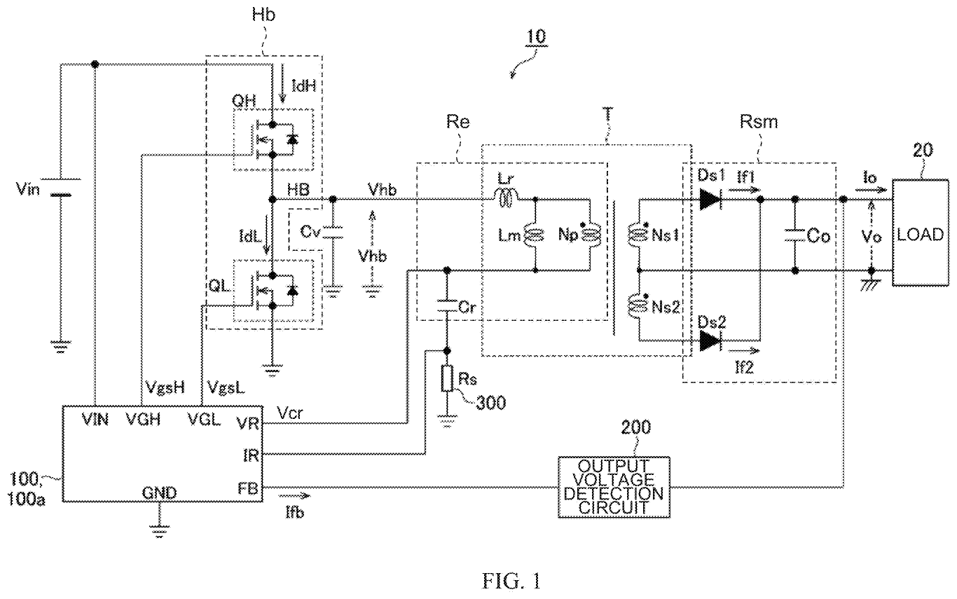

FIG. 1 illustrates a configuration of the LLC converter 10 according to an example embodiment of the disclosure. The LLC converter 10 includes an input power supply Vin and a half bridge circuit Hb. The half bridge circuit Hb may be coupled to the input power supply Vin. The half bridge circuit Hb includes a high side switch QH and a low side switch QL. The LLC converter 10 further includes a resonant circuit Re coupled between an output HB of the half bridge circuit Hb and a ground GND. The resonant circuit Re includes a primary winding Np of a transformer T and a resonant capacitor Cr that are coupled in series to each other. Further, a voltage resonant capacitor Cv may be coupled between the output HB and the ground GND. In some embodiments, the voltage resonant capacitor Cv may include output capacitances Coss of the high side switch QH and the low side switch QL.

The LLC converter 10 further includes a rectifying and smoothing circuit Rsm. The rectifying and smoothing circuit Rsm includes a first diode Ds1, a second diode Ds2, and an output capacitor Co, and is configured to rectify and smooth respective currents flowing through secondary windings Ns1 and Ns2 of the transformer T. The LLC converter 10 further includes an output voltage detection circuit 200 configured to detect an output voltage Vo. The LLC converter 10 further includes a resonant current detection circuit 300 configured to detect a resonant current Ires flowing through the resonant circuit Re.

The LLC converter 10 may further include the LLC converter control circuit 100 or 100a to control the high side switch QH and the low side switch QL. The LLC converter control circuits 100 and 100a may each control a high side driving signal VgsH and a low side driving signal VgsL, based on a feedback current Ifb outputted from the output voltage detection circuit 200 and the resonant current Ires detected by the resonant current detection circuit 300.

The resonant current Ires is a current flowing through the resonant circuit Re that resonates through alternate turning-on and turning-off of the high side switch QH and the low side switch QL. The high side driving signal VgsH is adapted to drive the high side switch QH. The low side driving signal VgsL is adapted to drive the low side switch QL. In the LLC converter 10, the output voltage Vo may be controlled based on the high side driving signal VgsH and the low side driving signal VgsL.

### Configuration of LLC Converter Control Circuit 100 According to Comparative Example

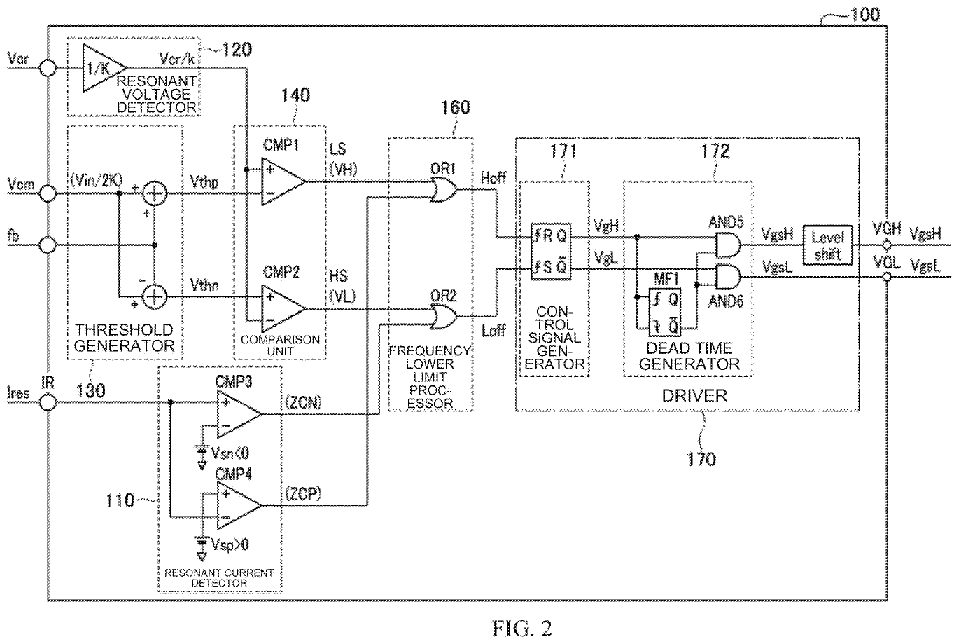

FIG. 2 is a diagram for describing the LLC converter control circuit 100 according to the comparative example. The LLC converter control circuit 100 according to the comparative example illustrated in FIG. 2 may include a resonant current detector 110, a resonant voltage detector 120, a threshold generator 130, a comparison unit 140, a frequency lower limit processor 160, and a driver 170.

The LLC converter control circuit 100 controls the high side driving signal VgsH and the low side driving signal VgsL, based on a resonant voltage Vcr. The resonant voltage Vcr is a voltage as a resultant of conversion from the resonant current Ires flowing through the resonant circuit Re that resonates through alternate turning-on and turning-off of the high side switch QH and the low side switch QL.

The LLC converter control circuit 100 may receive the resonant voltage Vcr of the resonant capacitor Cr, a reference voltage Vcm, a feedback voltage fb, and a voltage proportional to the resonant current Ires. Further, the LLC converter control circuit 100 generates the high side driving signal VgsH and the low side driving signal VgsL for controlling the high side switch QH and the low side switch QL, respectively. The reference voltage Vcm may be set to ½×Vin/K. This helps to control the high side driving signal VgsH and the low side driving signal VgsL to be symmetrical.

The resonant current detector 110 may perform a comparison between a voltage corresponding to the resonant current Ires and each of a first reference voltage Vsp having a positive voltage value and a second reference voltage Vsn having a negative voltage value. For example, in a case where the voltage corresponding to the resonant current Ires is lower than the first reference voltage Vsp, the resonant current detector 110 may set a first current detection signal ZCP to a high level. In a case where the voltage corresponding to the resonant current Ires is higher than the second reference voltage Vsn, the resonant current detector 110 may set a second current detection signal ZCN to a high level.

The resonant voltage detector 120 may detect the resonant voltage Vcr of the resonant capacitor Cr and generate a voltage Vcr/K that is equal to the resonant voltage Vcr multiplied by 1/K.

The threshold generator 130 generates a first threshold voltage Vthp and a second threshold voltage Vthn. The first threshold voltage Vthp may be equal to the reference voltage Vcm plus the feedback voltage fb. The second threshold voltage Vthn may be equal to the reference voltage Vcm minus the feedback voltage fb.

For example, the threshold generator 130 generates the first threshold voltage Vthp and the second threshold voltage Vthn, based on the feedback voltage fb and an input voltage Vin of the LLC converter 10. The first threshold voltage Vthp is a threshold voltage for generating the high side driving signal VgsH. The second threshold voltage Vthn is a threshold voltage for generating the low side driving signal VgsL. The threshold generator 130 may so generate the second threshold voltage Vthn as to be greater in voltage value than the first threshold voltage Vthp even in a case where no load 20 is coupled to the LLC converter 10, in other words, even in a case where the feedback voltage fb is at a minimum value.

The comparison unit 140 performs a comparison between a signal as a resultant of amplification of the resonant voltage Vcr and each of the first threshold voltage Vthp and the second threshold voltage Vthn. The comparison unit 140 outputs a result of the comparison between the signal and the first threshold voltage Vthp as a first comparison result signal VH, and outputs a result of the comparison between the signal and the second threshold voltage Vthn as a second comparison result signal VL.

For example, the comparison unit 140 may include a comparator CMP1 and a comparator CMP2. The comparator CMP1 may perform a comparison between the voltage Vcr/K and the first threshold voltage Vthp and output the first comparison result signal VH. The first comparison result signal VH may be at a high level (“H”) when the voltage Vcr/K is higher than the first threshold voltage Vthp. The comparator CMP2 may perform a comparison between the voltage Vcr/K and the second threshold voltage Vthn and output the second comparison result signal VL. The second comparison result signal VL may be at a high level (“H”) when the voltage Vcr/K is lower than the second threshold voltage Vthn.

The frequency lower limit processor 160 may include an OR circuit OR1 that receives the first comparison result signal VH and the first current detection signal ZCP and outputs a high side off signal Hoff. The frequency lower limit processor 160 may further include an OR circuit OR2 that receives the second comparison result signal VL and the second current detection signal ZCN and outputs a low side off signal Loff.

The driver 170 may include a control signal generator 171, a dead time generator 172, and a level shifter. The control signal generator 171 may generate a first driving signal VgH and a second driving signal VgL. The dead time generator 172 may turn off the high side driving signal VgsH, based on the first driving signal VgH, and turn on the high side driving signal VgsH after a dead time. Further, the dead time generator 172 may turn off the low side driving signal VgsL, based on the second driving signal VgL, and turn on the low side driving signal VgsL after a dead time.

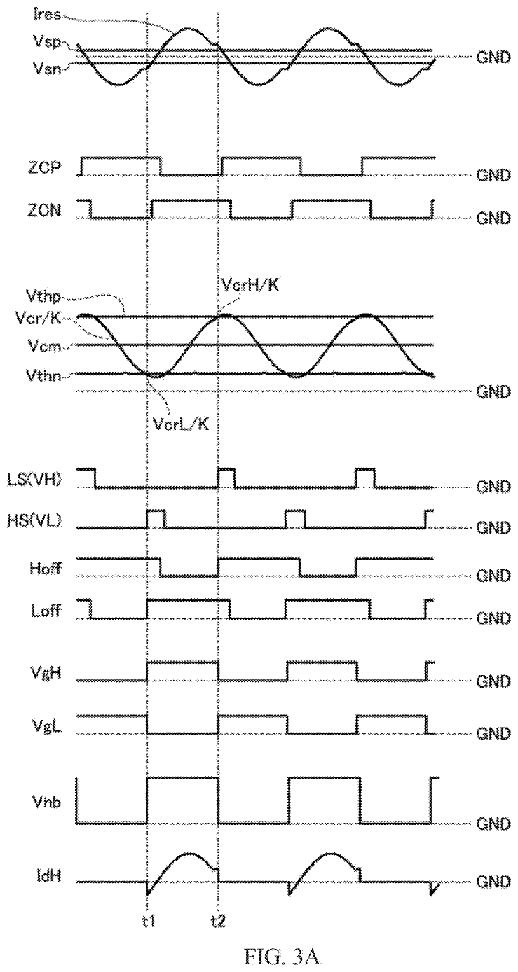

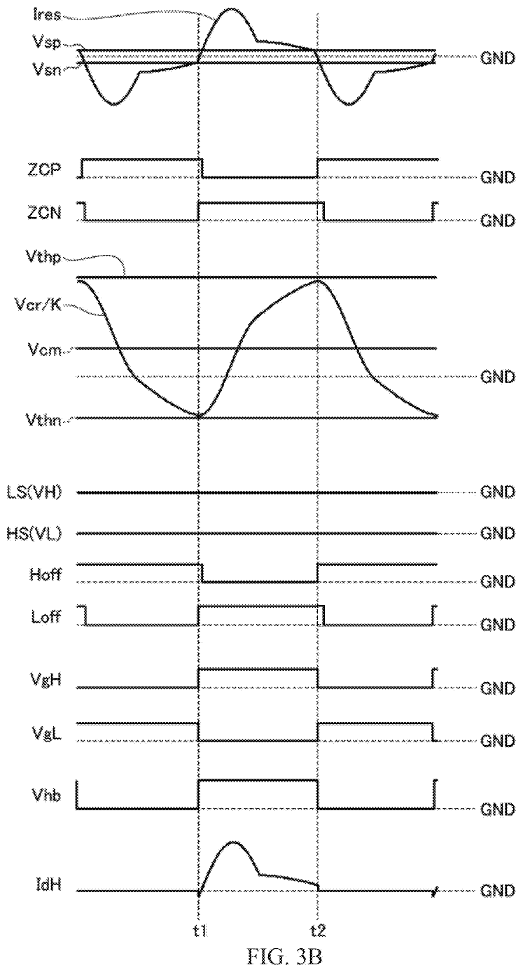

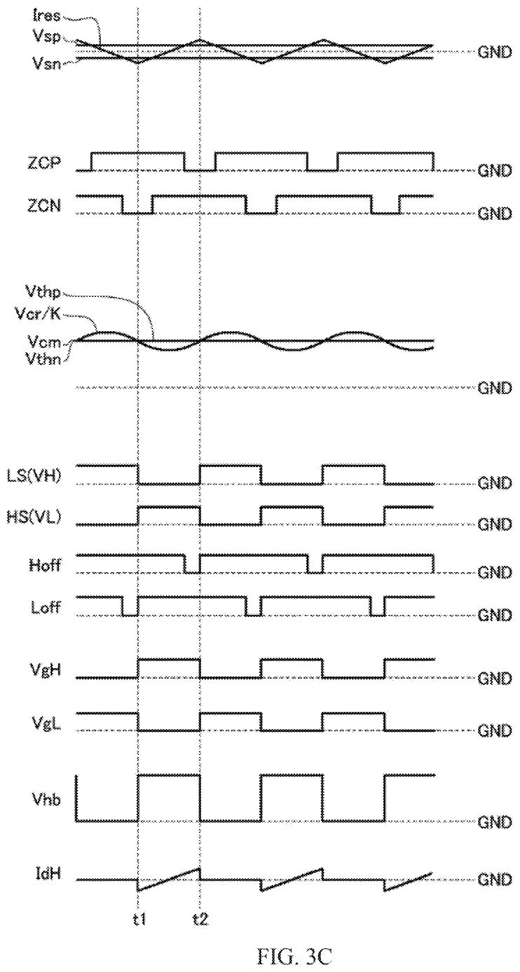

Reference is now made to FIGS. 3A to 3C to describe an operation of the LLC converter control circuit 100 according to the comparative example illustrated in FIG. 2. FIGS. 3A to 3C illustrate operating waveforms according to the comparative example in a case where the voltage resonant capacitor Cv is 0 F. FIG. 3A illustrates operating waveforms under control according to an existing technique. FIG. 3B illustrates operating waveforms in a case where protection control by the frequency lower limit processor 160 is in operation. FIG. 3C illustrates operating waveforms under the control according to the existing technique in a case with an output current at no load. It is to be noted that in FIGS. 3A to 3C and other waveform diagrams similar thereto, “Ires” represents the voltage corresponding to the resonant current Ires.

As a precondition, under normal operating conditions of the LLC converter 10, each of the high side switch QH and the low side switch QL may be turned on at a timing when a voltage applied to opposite one of the switches QH and QL becomes 0 V or below after turning-off of the opposite one of the switches QH and QL.

Such ON-timing control may be executed, for example, through a fixed dead time or by observing a voltage of the half bridge circuit to thereby turn on each of the switches QH and QL when the voltage at opposite one of the switches QH and QL becomes 0 V or below. In some embodiments, each of the switches QH and QL may be turned on at a bottom of voltage oscillation of opposite one of the switches QH and QL in a case where the voltage at the opposite one of the switches QH and QL does not fall to 0 V.

The LLC converter 10 may be a converter allowing for zero voltage switching (ZVS). The high side switch QH and the low side switch QL may be alternately turned on and off, each with a duty ratio of 50%, and with a dead time to achieve ZVS. Accordingly, control on the LLC converter 10 may be executed through OFF-timing control on the high side switch QH and the low side switch QL. The description herein will thus focus on the OFF-timing control, and a description of the ON-timing control will be omitted.

Under the control according to the comparative example, as indicated by a circuit configuration illustrated in FIG. 2, an OFF timing of the low side switch QL may be at a rising edge of the second current detection signal ZCN or a rising edge of a signal HS(VL). Further, an OFF timing of the high side switch QH may be at a rising edge of the first current detection signal ZCP or a rising edge of a signal LS(VH).

Referring to FIG. 3A, at a time t1, the voltage Vcr/K may become lower than the second threshold voltage Vthn and the signal HS(VL) may change to a high level. At this timing, the second driving signal VgL may change to a low level (“L”) to cause the low side switch QL to be turned off. At a time t2, the voltage Vcr/K may become higher than the first threshold voltage Vthp and the signal LS(VH) may change to a high level. At this timing, the first driving signal VgH may change to a low level (“L”) to cause the high side switch QH to be turned off.

FIG. 3C illustrates operating waveforms in a case where a load current is zero. At the time t1, as in FIG. 3A, the voltage Vcr/K may become lower than the second threshold voltage Vthn and the signal HS(VL) may change to the high level. At this timing, the second driving signal VgL may change to the low level (“L”) to cause the low side switch QL to be turned off.

FIG. 3B illustrates operating waveforms in a case with an output current corresponding to electric power higher than or equal to electric power outputtable by the LLC converter 10. Increasing the output current does not vary the OFF timings. For convenience, the operating waveforms in this case are illustrated on the assumption that the output current is unchanged with the input voltage lowered.

At the time t1, the voltage Vcr/K may be higher than the second threshold voltage Vthn; however, the voltage corresponding to the resonant current Ires may become higher than the second reference voltage Vsn and the second current detection signal ZCN may change to the high level. At this timing, the low side switch QL may be turned off. At the time t2, the voltage Vcr/K may be lower than the first threshold voltage Vthp; however, the voltage corresponding to the resonant current Ires may become lower than the first reference voltage Vsp and the first current detection signal ZCP may change to the high level. At this timing, the high side switch QH may be turned off.

The resonant voltage Vcr of the resonant capacitor Cr at the time t1 in FIG. 3A will be denoted as VcrL, and the resonant voltage Vcr of the resonant capacitor Cr at the time t2 in FIG. 3A will be denoted as VcrH. In a case where ON and OFF operations of the low side switch QL and those of the high side switch QH are symmetrical, that is, in a case where respective ON durations of the low side switch QL and the high side switch QH are equal, a sum of VcrL and VcrH, i.e., VcrL+VcrH, is equal to a voltage of the input power supply Vin. It is thus known that a relation between input power Pin and VcrL, VcrH, and the voltage of the input power supply Vin is represented by Equation (1) below:

Pin=Cr×Vin×ΔVcr×fsw (1)

where ΔVcr=VcrH−VcrL.

Ignoring losses, output power Po is equal to the input power Pin. It is thus seen that to control the output power at zero, that is, to control the output current at zero, ΔVcr is to be set to zero. Accordingly, the first threshold voltage Vthp and the second threshold voltage Vthn of the LLC converter control circuit 100 are to satisfy Vthp=Vthn. In FIG. 3C, it is seen that the first threshold voltage Vthp and the second threshold voltage Vthn are set to be equal to allow the output current to be controlled at 0 A, and the output voltage is controlled at 12 V. It is seen that because the output current is zero or more, the output current is controllable over a range from no load to maximum power by so generating the first and second threshold voltages that Vthp≥Vthn. At maximum power, the frequency lower limit processor 160 of FIG. 3B may come into operation.

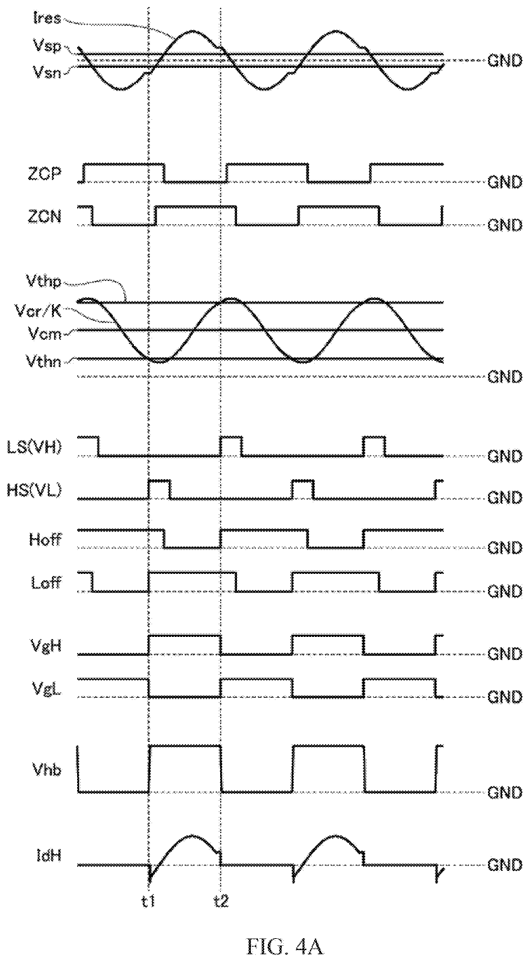

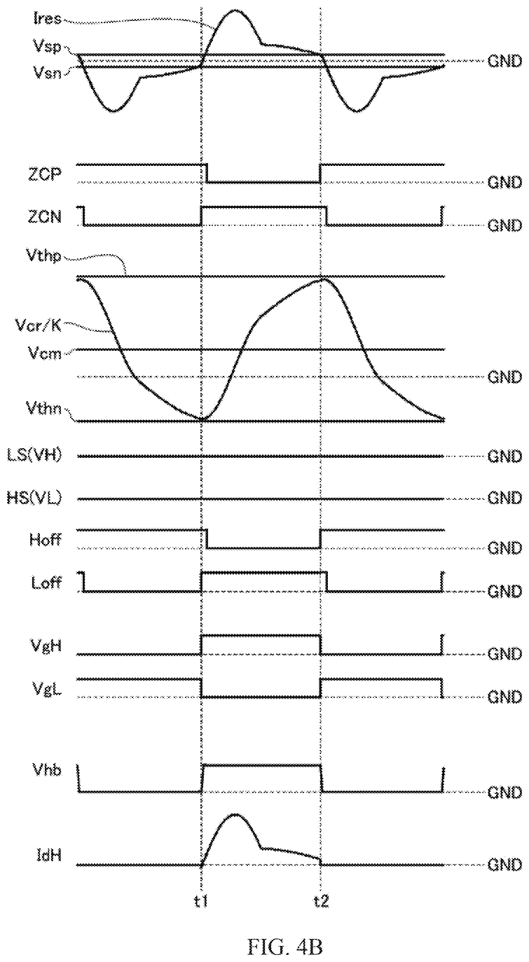

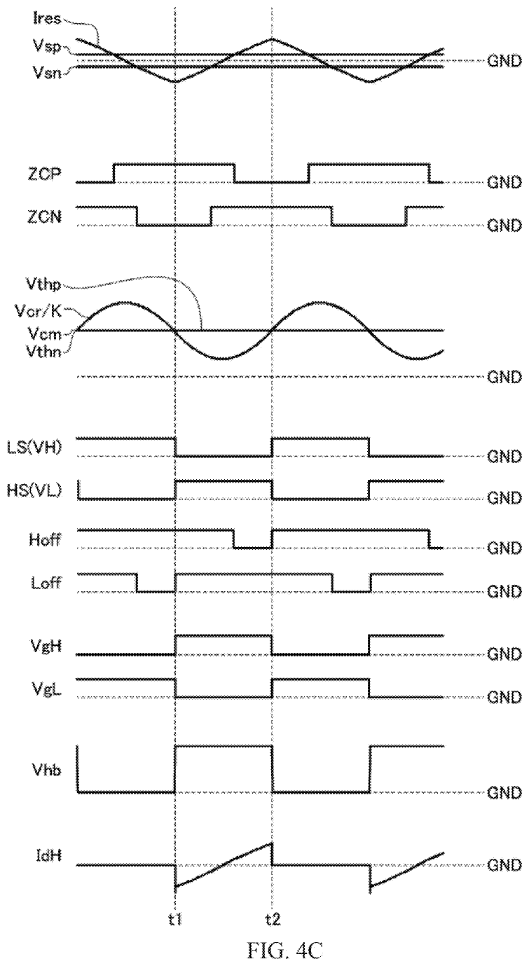

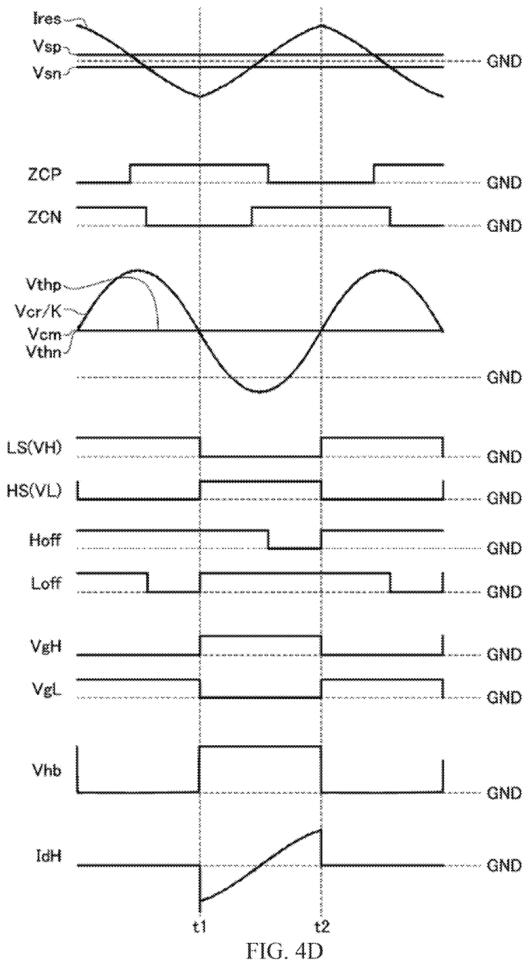

FIGS. 4A to 4D illustrate operating waveforms according to the comparative example in a case where the voltage resonant capacitor Cv is 300 pF. FIG. 4A illustrates operating waveforms under the control according to the existing technique. FIG. 4B illustrates operating waveforms in the case where the protection control by the frequency lower limit processor 160 is in operation. FIG. 4C illustrates operating waveforms under the control according to the existing technique in a case with an output current at light load (Io=0.1 A). FIG. 4D illustrates operating waveforms under the control according to the existing technique in the case with the output current at no load (Io=0 A).

The operating waveforms in FIGS. 4A and 4B indicate that timings of operation are substantially the same as those illustrated in the operating waveforms of FIGS. 3A and 3B obtained in the case where the voltage resonant capacitor Cv is 0 F. FIG. 4D illustrates the operating waveforms in the case where the load current is zero; however, it is seen that the resonant voltage Vcr exhibits a higher frequency than in FIG. 3C, which indicates a rise in output voltage.

When the voltage resonant capacitor Cv is added, a relation between the output power Po and the resonant voltage Vcr of the resonant capacitor Cr at the time when each switch is turned off may be represented by Equation (2) below:

Po={Cr×Vin×(VcrH−VcrL)+Cv×Vin²}×fsw (2).

For example, the following equation may hold: Po=300 pF×(380 V)² ×100 kHz=4.332 W. This indicates that an output current of 0.36 A or below will result in a rise in output voltage. It is thus seen that controlling the output voltage to be constant at light load is difficult.

To prevent the rise in output voltage at light load, it would be necessary to satisfy Equation (3) below:

Vcrh−Vcrl≤−(Cv/Cr)×Vin (3).

That is, it would be necessary to satisfy Equation (4) below:

Vthp−Vthn≤−(Cv/Cr)×Vin/K (4).

This would make it necessary for the threshold generator 130 to set the second threshold voltage Vthn to be greater than or equal to the first threshold voltage Vthp.

However, when Vthp−Vthn becomes smaller than −(Cv/Cr)×Vin/K, the frequency of the resonant voltage Vcr will excessively rise, which can result in stoppage of oscillation.

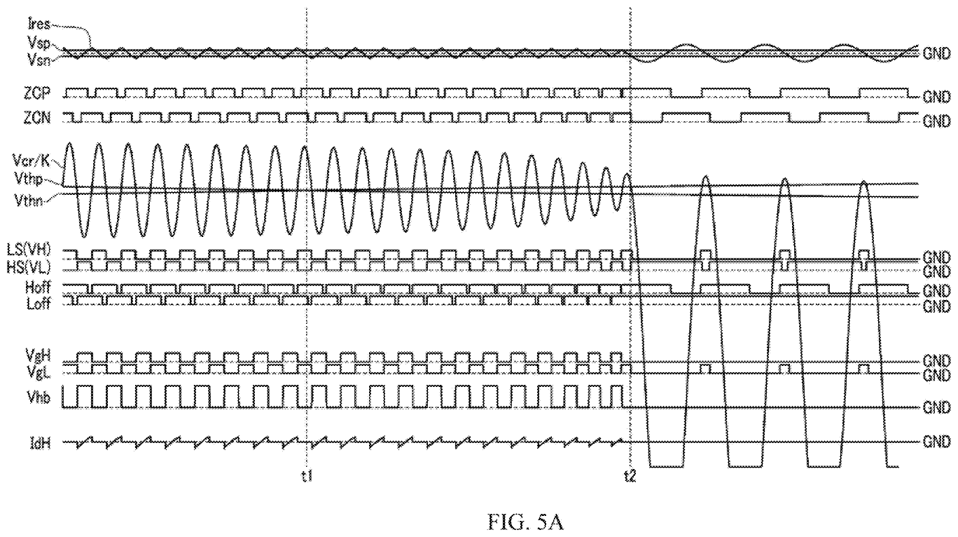

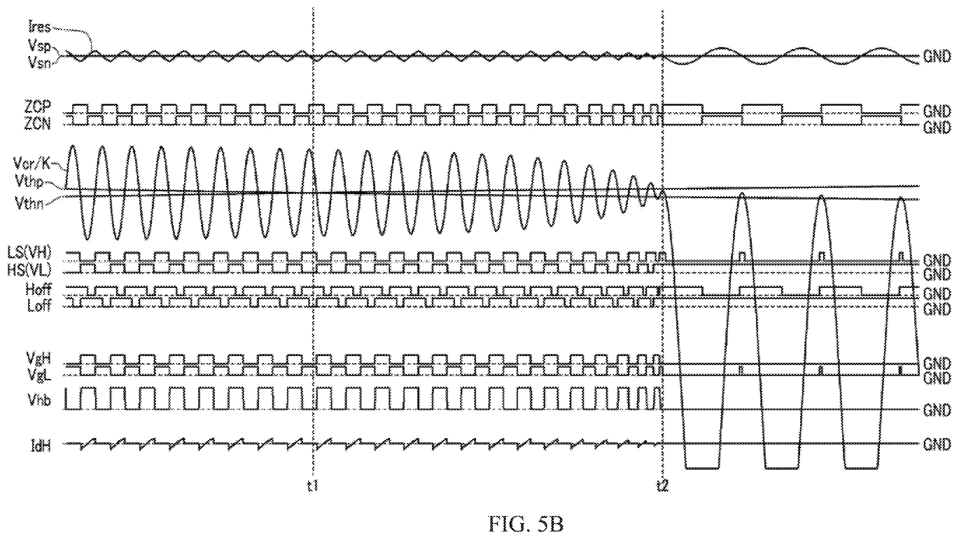

FIG. 5A illustrates operating waveforms in a case where the threshold generator 130 alone is modified to allow Vthp−Vthn to be smaller than −(Cv/Cr)×Vin/K and where the load is changed from one that causes the output current to be 1 A to no load. The illustrated waveforms indicate a decreased difference between the first threshold voltage Vthp and the second threshold voltage Vthn, and indicate that at the time t1, the first threshold voltage Vthp becomes smaller than the second threshold voltage Vthn and the frequency of the resonant voltage Vcr starts to gradually rise. Further, before the second current detection signal ZCN changes to the low level at the time t2, the signal HS(VL) changes to the high level and no low side off signal Loff is outputted, resulting in stoppage of oscillation.

FIG. 5B illustrates operating waveforms in a case where the first reference voltage Vsp and the second reference voltage Vsn are made lower to cause the second current detection signal ZCN to change to the low level at an earlier time. Even with the LLC converter control circuit 100 adjusted in such a manner, the difference between the first threshold voltage Vthp and the second threshold voltage Vthn decreases and at the time t1, the first threshold voltage Vthp becomes smaller than the second threshold voltage Vthn and the frequency of the resonant voltage Vcr starts to gradually rise. Further, at the time t2, the voltage Vcr/K becomes unable to exceed the first threshold voltage Vthp and no low side off signal Loff is outputted, resulting in stoppage of oscillation.

To address this, the LLC converter control circuit 100a according to the example embodiment includes a threshold generator 130a configured to set the second threshold voltage Vthn to be greater than the first threshold voltage Vthp at no load. Further, the LLC converter control circuit 100a additionally includes a frequency upper limit processor 150a. This helps to allow the LLC converter control circuit 100a according to the example embodiment to control the LLC converter 10 to be stably operable even at no load.

### Configuration of LLC Converter Control Circuit 100a According to Example Embodiment

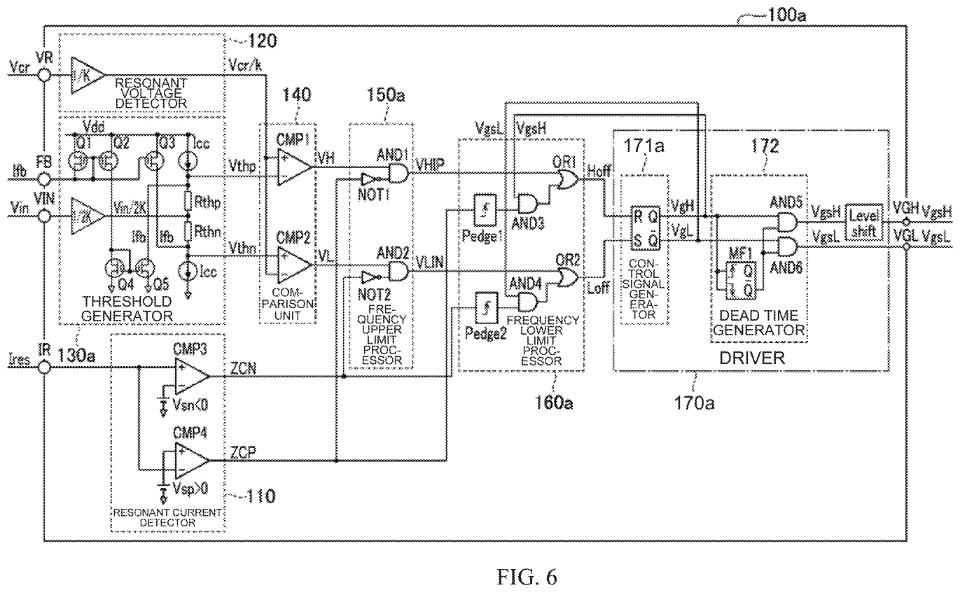

FIG. 6 is a diagram illustrating a configuration of the LLC converter control circuit 100a according to the example embodiment. The LLC converter control circuit 100a according to the example embodiment illustrated in FIG. 6 may be similar in configuration to the LLC converter control circuit 100 according to the comparative example illustrated in FIG. 2, except for: including the threshold generator 130a instead of the threshold generator 130; including a frequency lower limit processor 160a instead of the frequency lower limit processor 160; including a driver 170a instead of the driver 170; including a control signal generator 171a instead of the control signal generator 171; and further including the frequency upper limit processor 150a. It is to be noted that the control signal generator 171 illustrated in FIG. 2 may include a positive edge-triggered RS flip-flop, whereas the control signal generator 171a illustrated in FIG. 6 may include an RS flip-flop.

The threshold generator 130a according to the example embodiment may be configured as illustrated in FIG. 6, with a resistance Rthp and a resistance Rthn set to satisfy Rthp=Rthn. As a result, the first threshold voltage Vthp and the second threshold voltage Vthn are respectively expressible by Equations (5) and (6) below.

Vthp=Vin/2K+(Icc−Ifb)×Rthp (5)

Vthn=Vin/2K−(Icc−Ifb)×Rthn (6)

Accordingly, in a case where the feedback current Ifb is smaller than Icc, the second threshold voltage Vthn is smaller than the first threshold voltage Vthp, i.e., Vthp>Vthn. In a case where the feedback current Ifb is equal to Icc, the first threshold voltage Vthp and the second threshold voltage Vthn are equal to each other, and equal to Vin/2K, i.e., Vthp=Vthn=Vin/2K. Further, when the feedback current Ifb becomes greater than Icc, the second threshold voltage Vthn becomes greater than the first threshold voltage Vthp, i.e., Vthp<Vthn.

The frequency upper limit processor 150a may be configured as illustrated in FIG. 6. The frequency upper limit processor 150a generates a first inverted signal VHIP and a second inverted signal VLIN by respectively processing the first comparison result signal VH and the second comparison result signal VL, which are the results of the comparisons performed by the comparison unit 140, in accordance with the resonant current Ires of the LLC converter 10.

For example, in a case where the first comparison result signal VH of the comparison unit 140 is at the high level and where the first current detection signal ZCP is at a low level, the first inverted signal VHIP may change to a high level, and the high side off signal Hoff may change to a high level to cause the high side switch QH to be turned off.

Further, in a case where the second comparison result signal VL of the comparison unit 140 is at the high level and where the second current detection signal ZCN is at the low level, the second inverted signal VLIN may change to a high level, and the low side off signal Loff may change to a high level to cause the low side switch QL to be turned off.

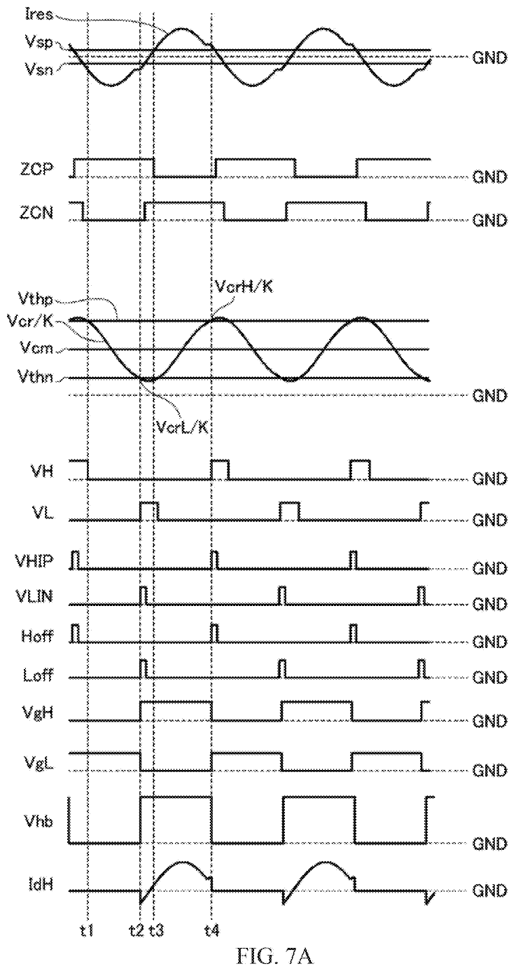

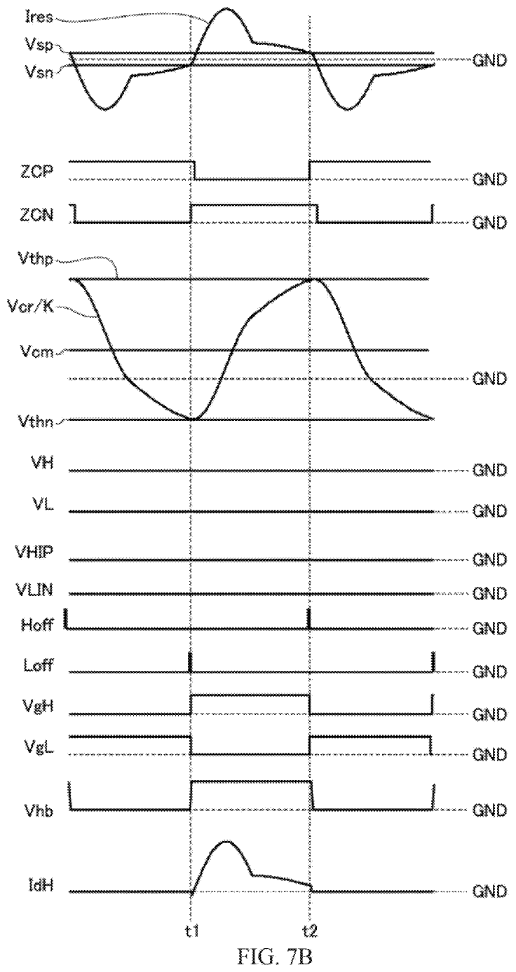

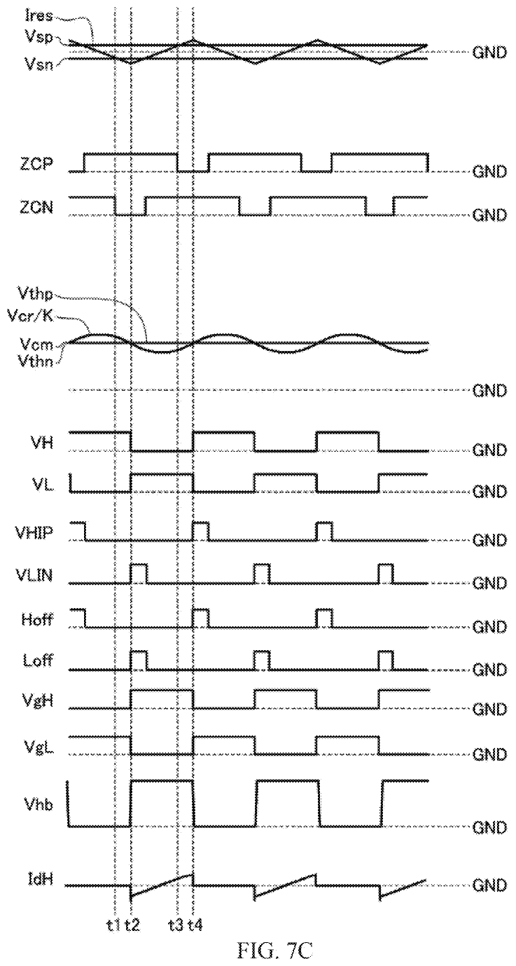

FIGS. 7A to 7C illustrate operating waveforms in the case where the voltage resonant capacitor Cv is 300 pF. FIG. 7A illustrates operating waveforms under control according to the example embodiment. FIG. 7B illustrates operating waveforms in a case where protection control by the frequency lower limit processor 160a is in operation. FIG. 7C illustrates operating waveforms under the control according to the example embodiment in a case with an output current at no load.

Referring to FIG. 7A, at the time t1, the voltage corresponding to the resonant current Ires may become lower than the second reference voltage Vsn and the second current detection signal ZCN may change to the low level. Further, due to the voltage Vcr/K being higher than the second threshold voltage Vthn, the second comparison result signal VL may be at a low level and the second inverted signal VLIN may remain at a low level.

At the time t2, the voltage corresponding to the resonant current Ires may remain lower than the second reference voltage Vsn and the second current detection signal ZCN may be at the low level. However, due to the voltage Vcr/K becoming lower than the second threshold voltage Vthn, the second comparison result signal VL may change to the high level. Further, the second inverted signal VLIN may change to a high level and the low side off signal Loff may change to a high level. Accordingly, the second driving signal VgL may change to the low level to cause the low side switch QL to be turned off.

At a time t3, the voltage corresponding to the resonant current Ires may become higher than the first reference voltage Vsp and the first current detection signal ZCP may change to a low level. However, due to the voltage Vcr/K being lower than the first threshold voltage Vthp, the first comparison result signal VH may be at a low level and the first inverted signal VHIP may remain at a low level.

At a time t4, the voltage corresponding to the resonant current Ires may remain higher than the second reference voltage Vsn and the first current detection signal ZCP may be at the low level. However, due to the voltage Vcr/K becoming higher than the first threshold voltage Vthp, the first comparison result signal VH may change to the high level. Further, the first inverted signal VHIP may change to a high level and the high side off signal Hoff may change to a high level. Accordingly, the first driving signal VgH may change to a low level to cause the high side switch QH to be turned off.

FIG. 7C illustrates operating waveforms in the case where the load current is zero. At the time t1, as in FIG. 7A, the voltage corresponding to the resonant current Ires may become lower than the second reference voltage Vsn and the second current detection signal ZCN may change to the low level. However, due to the voltage Vcr/K being higher than the second threshold voltage Vthn, the second comparison result signal VL may be at the low level and the second inverted signal VLIN may thus remain at the low level.

At the time t2, the voltage corresponding to the resonant current Ires may remain lower than the second reference voltage Vsn and the second current detection signal ZCN may be at the low level. However, due to the voltage Vcr/K becoming lower than the second threshold voltage Vthn, the second comparison result signal VL may change to the high level. Further, the second inverted signal VLIN may change to the high level and the low side off signal Loff may change to the high level. Accordingly, the second driving signal VgL may change to the low level to cause the low side switch QL to be turned off.

At the time t3, the voltage corresponding to the resonant current Ires may become higher than the first reference voltage Vsp and the first current detection signal ZCP may change to the low level. However, due to the voltage Vcr/K being lower than the first threshold voltage Vthp, the first comparison result signal VH may be at the low level and the first inverted signal VHIP may remain at the low level.

At the time t4, the voltage corresponding to the resonant current Ires may remain higher than the second reference voltage Vsn and the first current detection signal ZCP may be at the low level. However, due to the voltage Vcr/K becoming higher than the first threshold voltage Vthp, the first comparison result signal VH may change to the high level. Further, the first inverted signal VHIP may change to the high level and the high side off signal Hoff may change to the high level. Accordingly, the first driving signal VgH may change to the low level to cause the high side switch QH to be turned off.

FIG. 7B illustrates operating waveforms in the case with an output current corresponding to electric power higher than or equal to the electric power outputtable by the LLC converter 10. Increasing the output current does not vary the OFF timings. For convenience, the operating waveforms in this case are illustrated on the assumption that the output current is unchanged with the input voltage lowered.

At the time t1, the voltage Vcr/K may be higher than the second threshold voltage Vthn; however, the voltage corresponding to the resonant current Ires may become higher than the second reference voltage Vsn and the second current detection signal ZCN may change to the high level. At this timing, the low side switch QL may be turned off. At the time t2, the voltage Vcr/K may be lower than the first threshold voltage Vthp; however, the voltage corresponding to the resonant current Ires may become lower than the first reference voltage Vsp and the first current detection signal ZCP may change to the high level. At this timing, the high side switch QH may be turned off.

In this way, a control scheme for the LLC converter 10 according to the example embodiment helps to control the output voltage to be stable without a rise at no load. One reason for this is that the threshold generator 130a is configured to set the second threshold voltage Vthn to be higher than the first threshold voltage Vthp and the frequency upper limit processor 150a is provided to suppress an excessive rise in the frequency of the resonant voltage Vcr occurring at no load, which helps to allow the LLC converter 10 to stably operate without stoppage of oscillation.

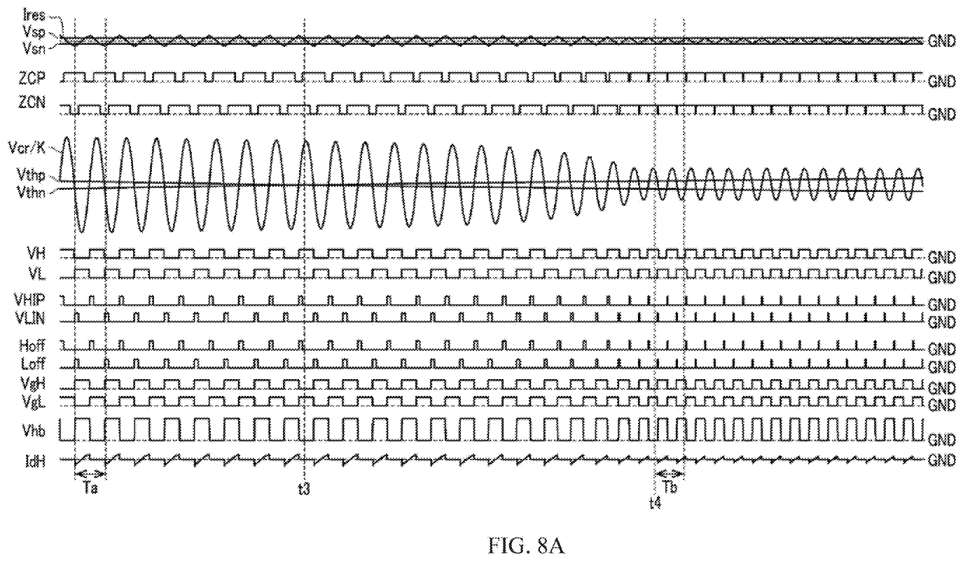

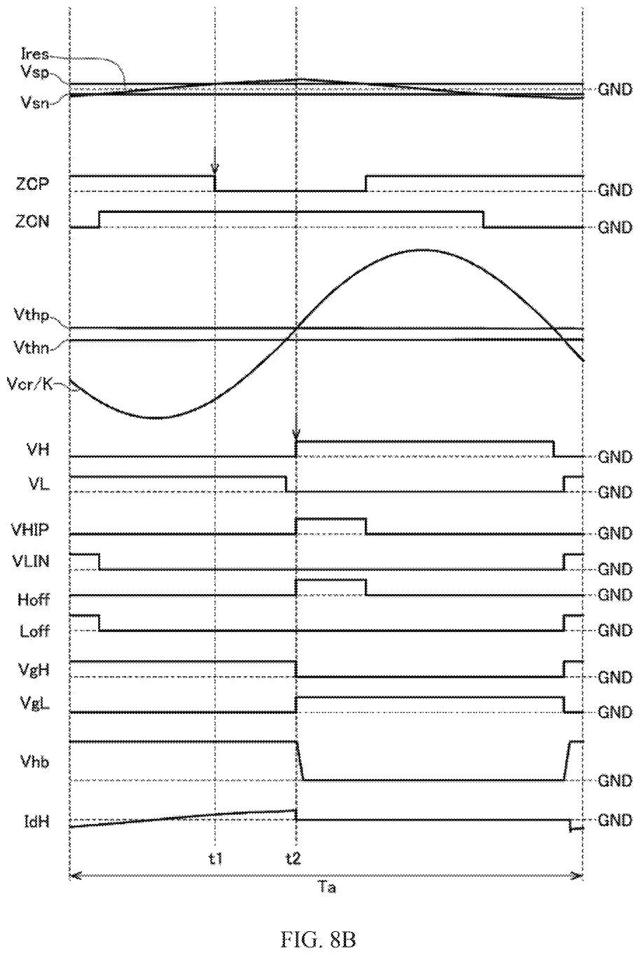

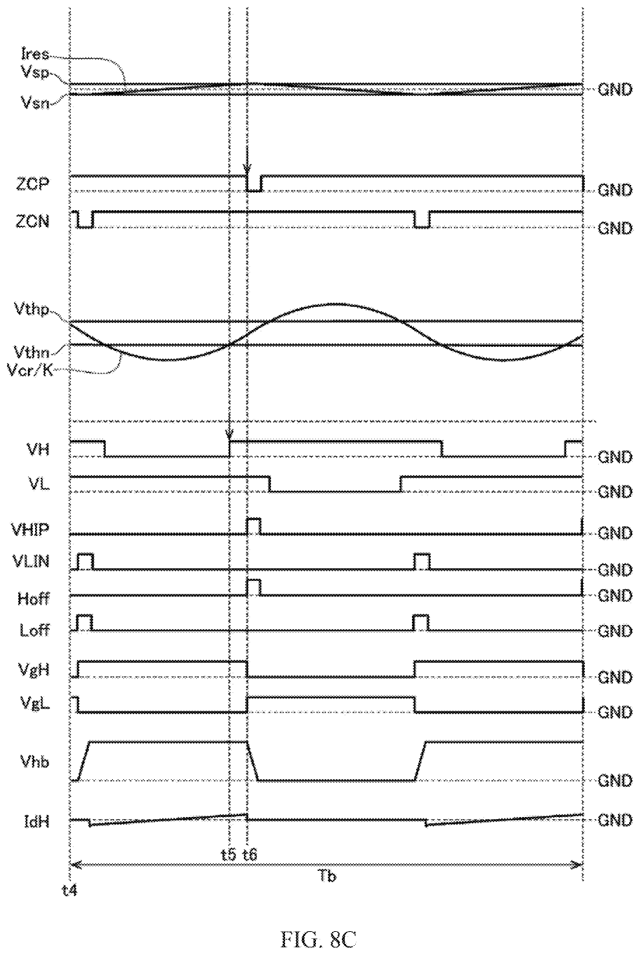

FIG. 8A illustrates operating waveforms under the control scheme for the LLC converter 10 according to the example embodiment in the case where the load is changed from the one that causes the output current to be 1 A to no load. The illustrated waveforms indicate a decreased difference between the first threshold voltage Vthp and the second threshold voltage Vthn, and indicate that at the time t3, the first threshold voltage Vthp becomes smaller than the second threshold voltage Vthn and the frequency of the resonant voltage Vcr starts to gradually rise. However, it is seen that the frequency no longer rises from the time t4 and the LLC converter 10 stably operates even thereafter.

FIGS. 8B and 8C illustrate enlarged operating waveforms during time periods Ta and Tb of FIG. 8A, respectively. During the time period Ta illustrated in FIG. 8B, the first current detection signal ZCP may change to the low level at the time t1, and at the time t2, the first comparison result signal VH may change to the high level to cause the high side off signal Hoff to change to the high level.

During the time period Tb illustrated in FIG. 8C, at a time t5, the first comparison result signal VH may change to the high level; however, due to the voltage corresponding to the resonant current Ires being lower than the first reference voltage Vsp, the first current detection signal ZCP may still remain at the high level, and accordingly, the high side off signal Hoff may remain at the low level. At a time t6, the voltage corresponding to the resonant current Ires may become higher than or equal to the first reference voltage Vsp and the first current detection signal ZCP may change to the low level, which may cause the first inverted signal VHIP to change to the high level to cause the high side off signal Hoff to change to the high level. The high side off signal Hoff may not change to the high level until the time t6. This means that the high side off signal Hoff may not change to the high level until the voltage corresponding to the resonant current Ires becomes higher than or equal to the first reference voltage Vsp.

Further, because the low side off signal Loff may operate in a similar manner, an amplitude of the voltage corresponding to the resonant current Ires may be maintained at least within a range from the first reference voltage Vsp to the second reference voltage Vsn. Accordingly, an upper limit of the frequency of the resonant voltage Vcr may be limited to the frequency at which the amplitude of the voltage corresponding to the resonant current Ires is maintained within the range from the first reference voltage Vsp to the second reference voltage Vsn. This helps to eliminate the stoppage of oscillation that would occur in the existing circuit, and accordingly helps to achieve stable operation even at no load.

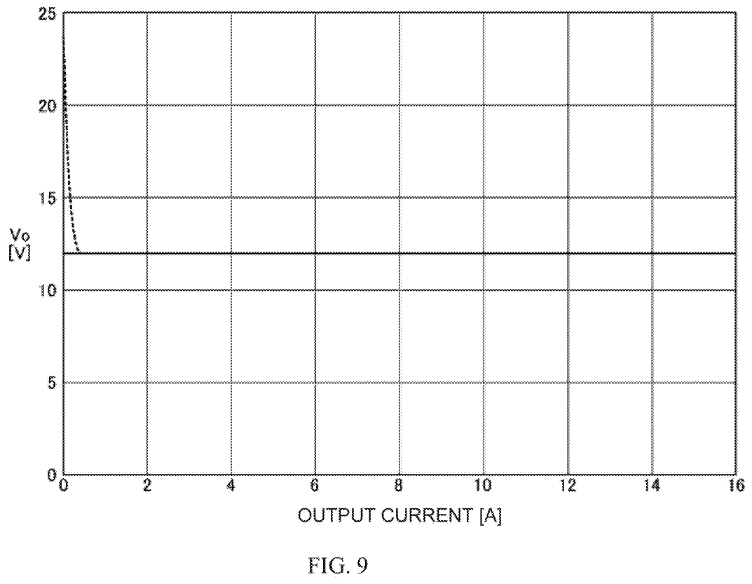

FIG. 9 is a graph illustrating output voltage characteristics obtained with the LLC converter control circuit 100a according to the example embodiment and the LLC converter control circuit 100 according to the comparative example in a case where the output current is varied.

In the graph of FIG. 9, a solid line represents a waveform obtained with the LLC converter control circuit 100a according to the example embodiment in a case where the voltage resonant capacitor Cv is 0 pF and in a case where the voltage resonant capacitor Cv is 300 pF. Further, in the graph of FIG. 9, a dashed line represents a waveform obtained with the LLC converter control circuit 100 according to the comparative example in the case where the voltage resonant capacitor Cv is 300 pF. The solid line also represents a waveform obtained with the LLC converter control circuit 100 according to the comparative example in the case where the voltage resonant capacitor Cv is 0 pF.

When the voltage resonant capacitor Cv is 0 pF, the comparative example and the example embodiment both help to control the output voltage to be constant even at no load. When the voltage resonant capacitor Cv is 300 pF, the LLC converter control circuit 100a according to the example embodiment helps to control the output voltage to be constant. In contrast, with the control circuit according to the comparative example when the voltage resonant capacitor Cv is 300 pF, controlling the output voltage at a constant value (Vo=12 V) is difficult at light load (io=0.3 A or less), and as a result, the output voltage may exceed the controlled value of 12 V.

The rise of the output voltage at light load may be suppressed by performing a burst operation in which stopping and starting of a switching operation are performed intermittently. However, the burst operation can lead to a possibility that a burst period falls within an audible frequency range to cause audible noise to occur from a component of the LLC converter 10 such as the transformer T.

To address this, the existing technique described herein as the comparative example has proposed the control method for the LLC converter 10 to enable easy designing of a feedback loop and to achieve high responsivity. There is, however, room for improvement with regard to the rise in output voltage at light load.

In contrast, using the LLC converter control circuit 100a according to the example embodiment to control the LLC converter 10 helps to achieve a stable output voltage even at light load, to enable easy designing of a feedback loop, and to achieve high responsivity.

### OTHER EMBODIMENTS

Although some example embodiments of the disclosure have been described in detail with reference to the accompanying drawings, the disclosure is by no means limited by what is described in relation to such example embodiments above. Further, the components described hereinabove include those that may be readily conceived by a person skilled in the art and those that are substantially the same. Still further, any two or more of the configurations described hereinabove may be combined as appropriate. It is to be appreciated that various omissions, alterations, and modifications may be made to any of the configurations without departing from the gist of embodiments of the disclosure.

Features of the LLC converter control circuit 100a and the LLC converter 10 are described below.

In accordance with one embodiment of the disclosure, the LLC converter control circuit 100a is configured to control the high side driving signal VgsH and the low side driving signal VgsL, based on the resonant voltage Vcr. The resonant voltage Vcr is a voltage as a resultant of conversion from the resonant current Ires flowing through the resonant circuit Re configured to resonate through alternate turning-on and turning-off of the high side switch QH and the low side switch QL. The high side driving signal VgsH is adapted to drive the high side switch QH. The low side driving signal VgsL is adapted to drive the low side switch QL. The LLC converter control circuit 100a includes the threshold generator 130a. The threshold generator 130a is configured to generate the first threshold voltage Vthp and the second threshold voltage Vthn, based on the feedback voltage and the input voltage of the LLC converter 10. The first threshold voltage Vthp is a threshold voltage for generating the high side driving signal VgsH. The second threshold voltage Vthn is a threshold voltage for generating the low side driving signal VgsL and is greater in voltage value than the first threshold voltage Vthp in the case where no load 20 is coupled to the LLC converter 10. The LLC converter control circuit 100a further includes the comparison unit 140. The comparison unit 140 is configured to perform a comparison between a signal as a resultant of amplification of the resonant voltage Vcr and each of the first threshold voltage Vthp and the second threshold voltage Vthn, and is configured to output a result of the comparison between the signal and the first threshold voltage Vthp as the first comparison result signal VH and output a result of the comparison between the signal and the second threshold voltage Vthn as the second comparison result signal VL. The LLC converter control circuit 100a further includes the frequency upper limit processor 150a. The frequency upper limit processor 150a is configured to generate the first inverted signal VHIP and the second inverted signal VLIN by processing the first comparison result signal VH and the second comparison result signal VL, respectively, in accordance with the resonant current Ires of the LLC converter 10. The LLC converter control circuit 100a further includes the control signal generator 171. The control signal generator 171 is configured to generate the high side driving signal VgsH, based on the first inverted signal VHIP, and generate the low side driving signal VgsL, based on the second inverted signal VLIN.

With such a configuration, in the LLC converter control circuit 100a, the threshold generator 130a causes the second threshold voltage Vthn to become higher in voltage value than the first threshold voltage Vthp at no load. Further, the LLC converter control circuit 100a includes the frequency upper limit processor 150a. This helps to allow the LLC converter control circuit 100a to suppress an excessive rise in the frequency of the resonant voltage Vcr occurring at no load in the LLC converter 10 and to achieve stable operation of the LLC converter 10.

In accordance with another embodiment of the disclosure, the LLC converter control circuit 100a may further include the resonant current detector 110. The resonant current detector 110 may perform a comparison between the voltage corresponding to the resonant current Ires and each of the first reference voltage Vsp having a positive voltage value and the second reference voltage Vsn having a negative voltage value. For example, in a case where the voltage corresponding to the resonant current Ires is lower than the first reference voltage Vsp, the resonant current detector 110 may set the first current detection signal ZCP to the high level. Further, in a case where the voltage corresponding to the resonant current Ires is higher than the second reference voltage Vsn, the resonant current detector 110 may set the second current detection signal ZCN to the high level. Further, the frequency upper limit processor 150a may generate the first inverted signal VHIP to cause the high side switch QH to be turned off in a case where the first comparison result signal VH is at the high level and where the first current detection signal ZCP is at the low level. Further, the frequency upper limit processor 150a may generate the second inverted signal VLIN to cause the low side switch QL to be turned off in a case where the second comparison result signal VL is at the high level and where the second current detection signal ZCN is at the low level.

This configuration helps to allow the LLC converter control circuit 100a to control the upper limit of the frequency of the resonant voltage Vcr with higher accuracy, reflecting the state of the resonant current Ires, through the frequency upper limit processor 150a.

In accordance with still another embodiment of the disclosure, the LLC converter control circuit 100a may further include the frequency lower limit processor 160a. The frequency lower limit processor 160a may be configured to control a lower limit of a frequency of each of the first inverted signal VHIP and the second inverted signal VLIN. Further, the frequency lower limit processor 160a may generate the high side off signal Hoff and the low side off signal Loff. The high side off signal Hoff may cause the high side driving signal VgsH to be turned off. The low side off signal Loff may cause the low side driving signal VgsL to be turned off. The control signal generator 171 may be configured to generate the high side driving signal VgsH, based on the high side off signal Hoff, and generate the low side driving signal VgsL, based on the low side off signal Loff.

With such a configuration, the frequency lower limit processor 160a of the LLC converter control circuit 100a may control the lower limit of the frequency of each of the first inverted signal VHIP and the second inverted signal VLIN and generate the high side off signal Hoff and the low side off signal Loff. The control signal generator 171 may generate the high side driving signal VgsH and the low side driving signal VgsL, based on the high side off signal Hoff and the low side off signal Loff, respectively. That is, the LLC converter control circuit 100a may cause the high side driving signal VgsH to be generated based on the first inverted signal VHIP generated by the frequency upper limit processor 150a, and cause the low side driving signal VgsL to be generated based on the second inverted signal VLIN generated by the frequency upper limit processor 150a. This helps to allow the LLC converter control circuit 100a to suppress an excessive rise in the frequency of the resonant voltage Vcr occurring at no load in the LLC converter 10 with higher accuracy through the high side driving signal VgsH and the low side driving signal VgsL, and to achieve stabler operation of the LLC converter 10.

In accordance with yet another embodiment of the disclosure, the LLC converter 10 includes the LLC converter control circuit 100a described above, the input power supply Vin, and the half bridge circuit Hb. The half bridge circuit Hb includes the high side switch QH and the low side switch QL. The LLC converter 10 further includes the resonant circuit Re. The resonant circuit Re is coupled between the output HB of the half bridge circuit Hb and the ground GND, and includes the primary winding Np of the transformer T and the resonant capacitor Cr that are coupled in series to each other. The LLC converter 10 further includes the rectifying and smoothing circuit Rsm, the output voltage detection circuit 200, and the resonant current detection circuit 300. The rectifying and smoothing circuit Rsm includes the first diode Ds1, the second diode Ds2, and the output capacitor Co, and is configured to rectify and smooth the respective currents flowing through the secondary windings Ns1 and Ns2 of the transformer T. The output voltage detection circuit 200 is configured to detect the output voltage Vo. The resonant current detection circuit 300 is configured to detect the resonant current Ires flowing through the resonant circuit Re.

With such a configuration, in the LLC converter control circuit 100a of the LLC converter 10, the threshold generator 130a causes the second threshold voltage Vthn to become higher in voltage value than the first threshold voltage Vthp at no load. Further, the LLC converter control circuit 100a of the LLC converter 10 includes the frequency upper limit processor 150a. This helps to suppress an excessive rise in the frequency of the resonant voltage Vcr occurring at no load in the LLC converter 10 and allow the LLC converter 10 to achieve stable operation.

An embodiment of the disclosure may have any of the following configurations.
<1>

An LLC converter control circuit, the LLC converter control circuit being a control circuit for an LLC converter and configured to control a high side driving signal and a low side driving signal, based on a resonant voltage, the resonant voltage being a voltage as a resultant of conversion from a resonant current flowing through a resonant circuit configured to resonate through alternate turning-on and turning-off of a high side switch and a low side switch, the high side driving signal being adapted to drive the high side switch, the low side driving signal being adapted to drive the low side switch,

the LLC converter control circuit including:
a threshold generator configured to generate a first threshold voltage and a second threshold voltage, based on a feedback voltage and an input voltage of the LLC converter, the first threshold voltage being a threshold voltage for generating the high side driving signal, the second threshold voltage being a threshold voltage for generating the low side driving signal and being greater in voltage value than the first threshold voltage in a case where no load is coupled to the LLC converter;
a comparison unit configured to perform a comparison between a signal as a resultant of amplification of the resonant voltage and each of the first threshold voltage and the second threshold voltage, and configured to output a result of the comparison between the signal and the first threshold voltage as a first comparison result signal and output a result of the comparison between the signal and the second threshold voltage as a second comparison result signal;
a frequency upper limit processor configured to generate a first inverted signal and a second inverted signal by processing the first comparison result signal and the second comparison result signal, respectively, in accordance with the resonant current of the LLC converter; and
a control signal generator configured to generate the high side driving signal, based on the first inverted signal, and generate the low side driving signal, based on the second inverted signal.
<2>

The LLC converter control circuit according to <1>, further including a resonant current detector configured to perform a comparison between a voltage corresponding to the resonant current and each of a first reference voltage having a positive voltage value and a second reference voltage having a negative voltage value, the resonant current detector being configured to set a first current detection signal to a high level in a case where the voltage corresponding to the resonant current is lower than the first reference voltage, and set a second current detection signal to a high level in a case where the voltage corresponding to the resonant current is higher than the second reference voltage, in which
the frequency upper limit processor is configured to generate the first inverted signal to cause the high side switch to be turned off in a case where the first comparison result signal is at a high level and where the first current detection signal is at a low level, and
the frequency upper limit processor is configured to generate the second inverted signal to cause the low side switch to be turned off in a case where the second comparison result signal is at a high level and where the second current detection signal is at a low level.
<3>

The LLC converter control circuit according to <1>, further including a frequency lower limit processor configured to control a lower limit of a frequency of each of the first inverted signal and the second inverted signal, the frequency lower limit processor being configured to generate a high side off signal and a low side off signal, the high side off signal causing the high side driving signal to be turned off, the low side off signal causing the low side driving signal to be turned off, in which
the control signal generator is configured to generate the high side driving signal, based on the high side off signal, and generate the low side driving signal, based on the low side off signal.
<4>

An LLC converter including:
the LLC converter control circuit according to any one of <1>to <3>;
an input power supply;
a half bridge circuit including the high side switch and the low side switch;
the resonant circuit, the resonant circuit being coupled between an output of the half bridge circuit and a ground and including a primary winding of a transformer and a resonant capacitor that are coupled in series to each other;
a rectifying and smoothing circuit including a first diode, a second diode, and an output capacitor, and configured to rectify and smooth a current flowing through a secondary winding of the transformer;
an output voltage detection circuit configured to detect an output voltage; and
a resonant current detection circuit configured to detect the resonant current flowing through the resonant circuit.

With at least one embodiment of the disclosure, it is possible to provide an LLC converter control circuit that makes it possible to suppress an excessive rise in frequency of a resonant voltage occurring at no load in an LLC converter and thereby achieve stable operation of the LLC converter, and to provide an LLC converter including such an LLC converter control circuit.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

1. An LLC converter control circuit that controls an LLC converter and controls a high side driving signal and a low side driving signal, based on a resonant voltage that is a voltage as a resultant of conversion from a resonant current flowing through a resonant circuit that resonates through alternate turning-on and turning-off of a high side switch and a low side switch, the high side driving signal being adapted to drive the high side switch, the low side driving signal being adapted to drive the low side switch, the LLC converter control circuit comprising:
a threshold generator that generates a first threshold voltage and a second threshold voltage, based on a feedback voltage and an input voltage of the LLC converter, the first threshold voltage being a threshold voltage for generating the high side driving signal, the second threshold voltage being a threshold voltage for generating the low side driving signal and being greater in voltage value than the first threshold voltage in a case where no load is coupled to the LLC converter;
a comparator that compares a signal as a resultant of amplification of the resonant voltage and each of the first threshold voltage and the second threshold voltage, and outputs a result of a comparison between the signal and the first threshold voltage as a first comparison result signal and outputs a result of the comparison between the signal and the second threshold voltage as a second comparison result signal;
a frequency upper limit processor that generates a first inverted signal and a second inverted signal by processing the first comparison result signal and the second comparison result signal, respectively, in accordance with the resonant current of the LLC converter; and
a control signal generator that generates the high side driving signal, based on the first inverted signal, and generates the low side driving signal, based on the second inverted signal.

2. The LLC converter control circuit according to claim 1, further comprising a resonant current detector that compares between a voltage corresponding to the resonant current and each of a first reference voltage having a positive voltage value and a second reference voltage having a negative voltage value, the resonant current detector setting a first current detection signal to a high level in response to the voltage corresponding to the resonant current being lower than the first reference voltage, and setting a second current detection signal to a high level in response to the voltage corresponding to the resonant current being higher than the second reference voltage, wherein
the frequency upper limit processor generates the first inverted signal to cause the high side switch to be turned off in response to the first comparison result signal being at a high level and the first current detection signal being at a low level, and
the frequency upper limit processor generates the second inverted signal to cause the low side switch to be turned off in response to the second comparison result signal being at a high level and the second current detection signal being at a low level.

3. The LLC converter control circuit according to claim 1, further comprising a frequency lower limit processor that controls a lower limit of a frequency of each of the first inverted signal and the second inverted signal, the frequency lower limit processor generating a high side off signal and a low side off signal, the high side off signal causing the high side driving signal to be turned off, the low side off signal causing the low side driving signal to be turned off, wherein
the control signal generator generates the high side driving signal, based on the high side off signal, and generates the low side driving signal, based on the low side off signal.

4. An LLC converter comprising:
the LLC converter control circuit according to claim 1;
an input power supply;
a half bridge circuit comprising the high side switch and the low side switch;
the resonant circuit, the resonant circuit being coupled between an output of the half bridge circuit and a ground and including a primary winding of a transformer and a resonant capacitor that are coupled in series to each other;
a rectifying and smoothing circuit comprising a first diode, a second diode, and an output capacitor, and rectifying and smooth a current flowing through a secondary winding of the transformer;
an output voltage detection circuit that detects an output voltage; and
a resonant current detection circuit that detects the resonant current flowing through the resonant circuit.
